(19) United States
(12) Patent Application Publication
(10) Pub. No.: US 2025/0292278 A1
(43) Pub. Date: Sep. 18, 2025

(54) COMBINATORIAL TRADING SYSTEM AND METHOD

(71) Applicant: San Francisco Compute Company, San Francisco, CA (US)

(72) Inventors: Devansh Pandey, San Francisco, CA (US); Ricki Heicklen, San Francisco, CA (US); Alexander Gajewski, San Francisco, CA (US)

(21) Appl. No.: 19/079,330

(22) Filed: Mar. 13, 2025

Related U.S. Application Data
(60) Provisional application No. 63/565,465, filed on Mar. 14, 2024.

(51) Int. Cl. G06Q 30/0201; G06Q 30/0273; G06Q 40/04

(52) U.S. Cl. CPC G06Q 30/0206; G06Q 30/0275; G06Q 40/04

(57) ABSTRACT

A combinatorial trading system in which contracts are traded for one standardized type of node, wherein each contract may have a different number of interconnected GPU nodes, and methods for making and utilizing the same. The combinatorial trading system advantageously can support combinatorial two-sided auctions for standardized compute contracts that respect the interconnect requirements of customers training artificial intelligence (or AI) models and efficiently allocate compute at multiple timescales.

### CROSS-REFERENCE TO RELATED APPLICATIONS

This application claims the benefit of, and priority to, U.S. Provisional Application Ser. No. 63/565,465, filed Mar. 14, 2024, the disclosure of which is hereby incorporated herein by reference in its entirety and for all purposes.

### FIELD

The disclosed embodiments relate generally to the field of automatic trading compute and more particularly, but not exclusively, to combinatorial trading systems and methods in which contracts are traded for one standardized type of node, but each contract may have a different number of interconnected nodes.

### BACKGROUND

Standardized contracts can be traded via conventional central limit order books (or CLOBs). Conventional central limit order books, however, cannot guarantee that, if a plurality of contracts of a given type are purchased, each of the purchased contract will come from the same seller. Although purchasing contracts from different sellers does not pose any issue for most commodities, purchasing contracts for graphics processing units (or GPUs) from different sellers can be problematic because the graphics processing units may be located at different geographical (or physical) locations. Purchasing contracts for graphics processing units from the same seller can help ensure that each graphics processing unit is disposed at the same geographical (or physical) location.

As artificial intelligence (or AI) models scale up, the compute needs for these AI models increase exponentially. Much of the needed compute capacity is owned by third-party datacenters. The compute capacity is provided via computers that are assembled into clusters of tens to thousands of machines. To train a large model, these machines need to be provided in the same cluster or, if unfeasible, across as few distinct clusters as possible to facilitate communications at a very high rate via a very fast physical interconnect fabric. Two arbitrary machines located in different geographical regions of the world, however, cannot be arbitrarily combined.

In view of the foregoing, a need exists for an improved combinatorial trading system and method that overcomes the aforementioned obstacles and deficiencies of currently-available central limit order books and that allows buyers to specify indivisible orders for two or more graphics processing units.

### BRIEF DESCRIPTION OF THE DRAWINGS

FIG. 1A is a top-level block diagram illustrating an exemplary embodiment of a combinatorial trading system for communicating with a plurality of clusters each comprising a predetermined number of graphics processing units.

FIG. 1B is a top-level block diagram illustrating another exemplary embodiment of the combinatorial trading system of FIG. 1A, wherein one or more of the clusters is associated with a data center.

FIG. 2 is a top-level flow chart illustrating an exemplary embodiment of a combinatorial trading method for trading contracts for standardized types of nodes.

FIG. 3A is a top-level flow chart illustrating an exemplary alternative embodiment of the combinatorial trading method of FIG. 2, wherein the combinatorial trading method receives a request for a price quotation from a buyer and supports providing a quotation in response to the request.

FIG. 3B is a top-level flow chart illustrating an exemplary alternative embodiment of the combinatorial trading method of FIG. 3A, wherein the combinatorial trading method enables the buyer to place a limit order based upon the provided quotation.

FIG. 4A is a top-level flow chart illustrating another exemplary alternative embodiment of the combinatorial trading method of FIG. 2, wherein the combinatorial trading method receives a request for a price quotation from a seller and supports providing a quotation in response to the request.

FIG. 4B is a top-level flow chart illustrating an exemplary alternative embodiment of the combinatorial trading method of FIG. 4A, wherein the combinatorial trading method enables the seller to place a limit order based upon the provided quotation.

FIG. 5 is a top-level flow chart illustrating yet another exemplary alternative embodiment of the combinatorial trading method of FIG. 2, wherein the combinatorial trading method is configured for trading futures contracts.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

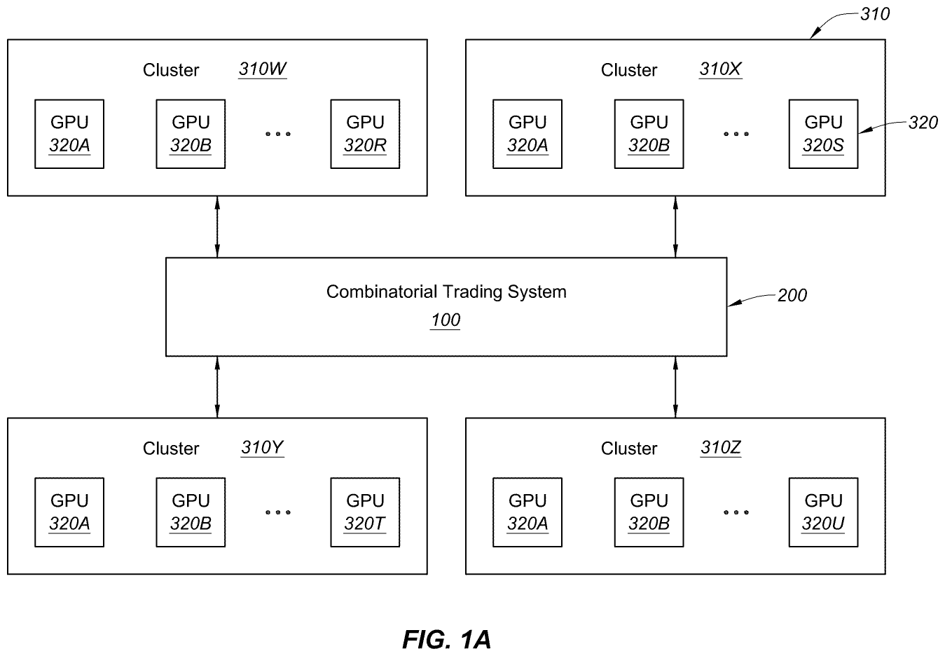

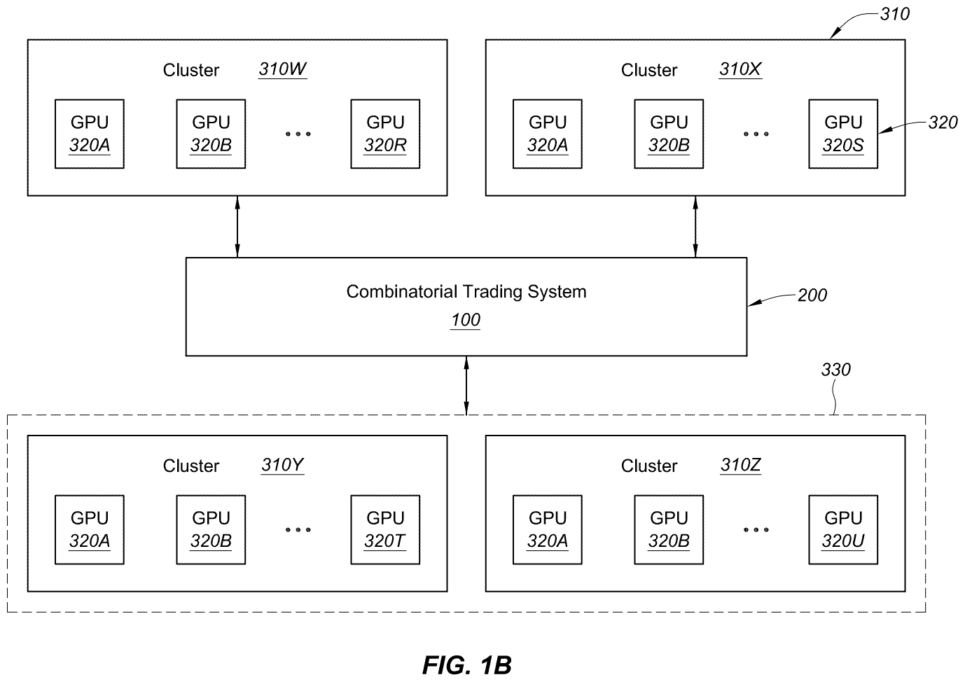

Since graphics processing unit (or GPU) technology presently does not support efficient training across clusters and currently-available central limit order books fail to enable buyers to specify that orders for graphics processing units are to be fulfilled with graphics processing units disposed at the same geographical (or physical) location and cannot guarantee that an order for plurality of contracts for graphics processing units will be fulfilled by the same seller, a combinatorial trading system and method in which contracts are traded for one standardized type of node, wherein each contract may have a different number of interconnected GPU nodes, can prove desirable and provide a basis for a wide range of applications, such as combinatorial two-sided auctions for standardized compute contracts that respect the interconnect requirements of customers training artificial intelligence (or AI) models and efficiently allocate compute at multiple timescales. This result can be achieved, according to one embodiment disclosed herein, by a combinatorial trading system 100 as illustrated in FIGS. 1A-B.

Turning to FIG. 1A, the combinatorial trading system 100 is shown as being configured to communicate with a plurality of clusters 310 each comprising a predetermined number of nodes, such as graphics processing units (or GPUs) 320 and/or other processing devices (or circuits). A first cluster 310W, for example, is shown as comprising a first predetermined number of GPU nodes 320A, 320B, . . . , 320R; whereas, a second cluster 310X can have a second predetermined number of GPU nodes 320A, 320B, . . . , 320S. Likewise, a third cluster 310Y can include a third predetermined number of GPU nodes 320A, 320B, . . . , 320T, and a fourth cluster 310Z can have a fourth predetermined number of GPU nodes 320A, 320B, . . . , 320U. The predetermined number of GPU nodes 320 can be uniform and/or different among the clusters 310.

In selected embodiments, one or more of the clusters 310 can be associated with a data center 330 as illustrated in FIG. 1B. Data centers 330 can be disposed in geographical regions that are proximal to the combinatorial trading system 100 and/or that are distributed around the world. Although shown and described as being configured to communicate with four clusters 310W, 310X, 310Y, 310Z that comprise GPU nodes 320 with reference to FIGS. 1A-B for purposes of illustration only, the combinatorial trading system 100 can communicate with any suitable number of clusters 310 each having any suitable number and/or type of nodes.

The combinatorial trading system 100 advantageously can execute or otherwise perform a combinatorial trading method 200 for automatically trading compute. If the combinatorial trading system 100 comprises a computer server or other processor-based system (or circuit), for example, the combinatorial trading method 200 can comprise a computer-implemented or processor-implemented method. To perform the automatically trading compute, the combinatorial trading method 200 can make the clusters 310 of GPU nodes 320 mutually interchangeable or fungible with one another. In selected embodiments, one or more differences among the clusters 310 can be addressed by establishing a standardized minimum specification for the clusters 310. An exemplary standardized minimum specification can include requiring each cluster 310 to have at least one terabyte (or 1TB) of random access memory (or RAM), at least a one hundred Gigabit per second (or 100 Gbps) network and/or at least a 3.2 Terabit per second (or Tbps) InfiniBand network, without limitation. The combinatorial trading method 200 can require that each cluster 310 satisfy the standardized minimum specification.

In selected embodiments, the combinatorial trading method 200 can be configured to trade contracts for one standardized type of GPU node 320 or other types of nodes. Each contract can have a uniform and/or different number of interconnected GPU nodes 320. The combinatorial trading method 200 thus can determine how many GPU nodes 320 are in any given cluster 310. Stated somewhat differently, the combinatorial trading method 200 can have access to a predetermined number of GPU nodes 320 a given cluster 310. Exemplary numbers of GPU nodes 320 per cluster 310 can range between one and one thousand twenty-four, without limitation. Within a datacenter 330, for example, clusters 310 can include odd numbers of GPU nodes 320 such as thirty-one, one hundred and twenty-seven and/or five hundred and eleven, such that the clusters 310 have one fewer than a power of two GPU nodes 320 for cost reasons. Additionally and/or alternatively, clusters 310 with a smaller numbers of GPU nodes 320, including, but not limited to, two, three, six and/or twelve GPU nodes 320, can be built and/or run for artificial intelligence applications.

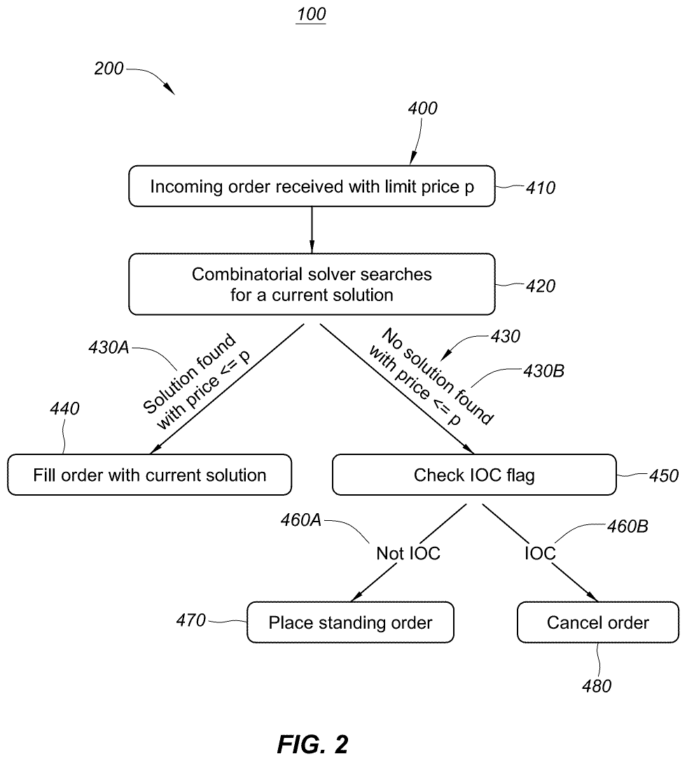

An exemplary embodiment of the combinatorial trading method 200 is shown in FIG. 2. Turning to FIG. 2, the combinatorial trading method 200 is illustrated as including a method 400 for performing market operations associated with trading contracts for one or more standardized types of GPU nodes 320. In selected embodiments, the market operations method 400 can support receiving and/or maintaining a collection of standing buy orders and/or standing sell orders.

The combinatorial trading method 200 can define a shape of a block of compute as a function for mapping discrete timesteps (or epochs) to a number of GPU nodes 320 in natural numbers. The shape of the block of compute can be zero at most times. Additionally and/or alternatively, the combinatorial trading method 200 can define a shape for each cluster 310. The shape of a cluster 310 can represent a number of the GPU nodes 320 that the cluster 310 has allocated to the market at any given time. The GPU nodes 320 may or may not yet have been sold. The combinatorial trading method 200 can support a set of outstanding contracts at any given time during the functioning of the market. Each outstanding contract can have a shape, which represents a preselected number of GPU nodes 320 that are associated with the contract at every point in time.

When coming onto the market, a new cluster 310 can be wholly allocated to a single originating contract, which can be owned by a seller of the new cluster 310. Each standing sell order can point to a backing contract from which a compute capacity can be sold. If the sell order is filled, the shape of the backing contract can be decremented by the shape of the filled sell order as long as the shape of the sell order is not greater than the shape of the backing contract. Each outstanding order likewise can have and maintain a provisional cluster assignment. A sum of the shapes of the contracts assigned to a cluster 310 preferably is equal to the shape of the cluster 310. If a cluster 310 has one or more unsold GPU nodes 320, a contract can be assigned to the cluster 310, and the contract can be owned by a seller of the cluster 310.

As shown in FIG. 2, the market operations method 400 can include, at 410, receiving an incoming order. The incoming order optionally can be associated with a price, such as a limit price p. At 420, a combinational solver (not shown) can search for a (current) solution. The combinatorial solver, in other words, can be invoked, at 420, to search for identifying a subset of the standing orders to fill, in addition to filling the incoming order, so as to maximize or otherwise optimize a sum of the prices of one or more identified buy orders less a sum of the prices of the one or more identified sell orders while maintaining an invariant that the resulting set of outstanding contracts can be assigned to the set of clusters 310 (shown in FIGS. 1A-B). The difference between the sum of the prices of the identified buy orders and the sum of the prices of the identified sell orders can comprise a surplus. The combinational solver may or may not find a solution with a nonnegative surplus. The set of identified buy orders and identified sell orders can be considered to comprise a matched group.

The market operations method 400, at 430, can determine whether the search identified a solution with a total price that is less than or equal to the limit price p. Stated somewhat differently, the market operations method 400, at 430, can determine whether the search identified a solution with a nonnegative surplus. If a solution with a nonnegative surplus (or a total price that is less than or equal to the limit price p) is identified during the search, at 430A, the market operations method 400 can fill the identified buy orders and the identified sell orders, at 440, based upon the current solution.

The market operations method 400, in selected embodiments, then can create new contracts for all filled buy orders and assign each contract to be owned by the who placed the buy order. For each filled sell order, the market operations method 400 can subtract a shape of the sell order from its backing contract. If the resulting contract is empty (or has zero shape), the market operations method 400 can delete the contract. Each filled standing buy order can pay its limit price p to the market, and/or each filled standing sell order can receive its limit price p from the market. In other words, an incoming buy order can pay its limit price p and optionally can receive a market surplus and/or pay a market trading fee; whereas, an incoming sell order can receive its limit price p optionally plus a market surplus and/or less a market trading fee.

At a start of a selected contract, the market operations method 400 initially can provide the owner of the selected contract with access to a predetermined number of GPU nodes 320 in the shape of the contract. The market operations method 400, for example, can provide the owner of the selected contract with Secure Shell (or SSH) access, bare metal access, access via Kubernetes, Slurm, or a virtual machine, or any other suitable delivery mechanism to the predetermined number of GPU nodes 320, without limitation. The market operations method 400 later can provide the contract owner with access to a number of GPU nodes 320 that is greater than the predetermined number of GPU nodes 320 initially accessible to the contract owner, that is less than the predetermined number of GPU nodes 320 or that is equal to the predetermined number of GPU nodes 320 based upon any change in the number of GPU nodes 320 in the shape of the contract. The contract owner, in other words, can be provided with access to the number of GPU nodes 320 in the shape of the contract regardless of whether the number is static or dynamic over time. When the selected contract ends, the market operations method 400 can revoke the contract owner's access to the GPU nodes 320 and/or delete all local data stored at the GPU nodes 320.

Alternatively, the market operations method 400, at 450, can check a flag status associated with the incoming order if no solution with a nonnegative surplus (or a total price that is less than or equal to the limit price p) is identified during the search, at 430B. One or more flags can be associated with the incoming order.

The incoming order, for example, can be associated with an immediate-or-cancel (or IOC) flag and/or a post only flag. An immediate-or-cancel flag fills an order only if it may be filled immediately when the order is received; otherwise, the order is discarded. A post only flag places an order only in the event that the order may not be filled immediately. If the incoming order is not associated with an immediate-or-cancel flag, at 460A, a standing order can be placed for the incoming order, at 470. The incoming order alternatively can be cancelled, at 480, if associated with an immediate-or-cancel flag, at 460B. Although shown and described with reference to GPU nodes 320 for purposes of illustration only, the combinatorial trading method 200 can utilize clusters 310 with any suitable type of node(s).

The market operations method 400 can define a shape of a block of compute as a function for mapping discrete timesteps (or epochs) to a number of GPU nodes 320 in natural numbers. The shape of the block of compute can be zero at most times. Additionally and/or alternatively, the market operations method 400 can define a shape for each cluster 310. The shape of a cluster 310 can represent a number of the GPU nodes 320 that the cluster 310 has allocated to the market at any given time. The GPU nodes 320 may or may not yet have been sold. The market operations method 400 can support a set of outstanding contracts at any given time during the functioning of the market. Each outstanding contract can have a shape, which represents a preselected number of GPU nodes 320 that are associated with the contract at every point in time. When coming onto the market, a new cluster 310 can be wholly allocated to a single originating contract, which can be owned by a seller of the new cluster 310.

In the manner discussed above, the market operations method 400 can maintain a collection of standing buy orders and/or standing sell orders. Each standing order can have a shape. The shape of a standing order can represent a preselected number of GPU nodes 320 that are intended to be bought at any given time. Although the market operations method 400 can support standing orders with any preselected order shape, the standing order preferably has a rectangular shape, meaning that the preselected number of GPU nodes 320 is zero at all times except for a contiguous period of time at which the preselected number of GPU nodes 320 is a constant, non-negative integer.

Each standing sell order can point to a backing contract from which a compute capacity can be sold. In selected embodiments, each standing sell order must point to a backing contract from which a compute capacity can be sold. If the sell order is filled, the shape of the backing contract can be decremented by the shape of the filled sell order as long as the shape of the sell order is not greater than the shape of the backing contract. Each outstanding order likewise can have and maintain a provisional cluster assignment. A sum of the shapes of the contracts assigned to a cluster 310 preferably is equal to the shape of the cluster 310. In selected embodiments, the sum of the shapes of the contracts assigned to a cluster 310 must be equal to the shape of the cluster 310. If a cluster 310 has one or more unsold GPU nodes 320, a contract can be assigned to the cluster 310, and the contract can be owned by a seller of the cluster 310.

The market operations method 400 can unpin any contracts owned by ordinary market participants at any time before the contract begins. The market operations method 400, in other words, can be free to move the unpinned contracts to any cluster 310. An originating contract for a cluster 310 can be initially pinned to the cluster 310. The market operations method 400 optionally can permit a provider of a cluster 310 and/or a provider of a data center 330 to buy back the capacity of the cluster 310 and/or the data center 330 by placing a pinned buy order, which may only be filled on a specific cluster 310 owned by the provider. Upon receiving an incoming buy order, the market operations method 400 can solve an optimization problem to minimize a price for the incoming buy order. The market operations method 400 similarly can solve an optimization problem to maximize a price for an incoming sell order. Stated somewhat differently, the market operations method 400 can choose a subset of standing buy orders and standing sell orders to fill as well as a new provisional assignment of clusters 310 for the new resulting set of outstanding contracts, which minimizes the price of the incoming buy order and/or maximizes minimizes the price of the incoming sell order.

The market operations method 400 can allocate any surplus in any suitable manner. In selected embodiments, the market operations method 400 can divide the surplus evenly across all filled orders in a single trade, proportional to their limit prices. The market operations method 400, additionally and/or alternatively, can identify which groups of filled orders are logically independent from one another and divide the surplus within each group in a manner that is proportional to the limit price of each order.

In selected embodiments, the market operations method 400 advantageously can subdivide the market into different geographical regions while still pooling all orders. Some orders thereby can request specific geographical regions; whereas, other orders can be flexible across all geographic regions. Additionally and/or alternatively, the market operations method 400 can support orders with colocation constraints. An order with a colocation restraint permits the order to be filled only if the order is assigned to the same cluster 310 as a cluster 310 associated with a contract held by the party who placed the order. The market operations method 400 may be unable to fill an order with a colocation restraint even though an unconstrained order would get filled.

The market operations method 400 can enable market participants to request a quote for a price that an order would receive if the order were to be placed immediately. In response to the request, the market operations method 400 can solve an optimization problem in the same manner that the optimization problem would be solved for an incoming order. The market operations method 400, here, would provide the price quotation without actually placing the order. The market operations method 400 optionally can enable market participants to request a flexible quote for a range of different order parameters, for example, between X and Y nodes, lasting for between Z and W days, and beginning at most R days from now. The market operations method 400 can provide a configuration that minimizes the unit price (or price per node-hour) as well as the price quotation. Additionally and/or alternatively, the market operations method 400 can support placement of flexible orders with a range of order parameters in a manner similar to flexible quoting and/or placement of batch orders. A batch order can comprise a collection of several individual orders that must all be filled or else none of the individual orders may be filled.

In selected embodiments, the market operations method 400 can support short-selling via use of long contracts and/or short contracts. A long contract can comprise a provisional assignment to a short contract that is meant to fulfill the long contract. A sum of the shapes of one or more long contracts that are assigned to a short contract can be equal to a shape of the short contract. When a provider of a cluster 310 sells the cluster 310 in the market, the provider can sell one or more short contracts instead of creating originating contracts in the manner discussed above. The market operations method 400 thereby can enable a speculator to also sell short contracts that may have long contracts provisionally assigned to them. The speculator then would be contractually obligated to deliver one or more clusters 310 to fulfill the sold short contracts or to exit the acquired positions. To exit the acquired positions, the market operations method 400 can enable the speculator to buy a contract of an equivalent shape or to acquire pinned buy orders that are pinned to the short contract to be exited.

The market operations method 400 optionally can enable one or more configuration parameters to be associated with an order. The configuration parameters can result in a software program running on at least one GPU node 320 if the order is filled. Use of the configuration parameters advantageously can help to automate training of an AI model as soon as a contract associated with the filled order begins.

In operation, the combinatorial trading method 200 can keep track of and otherwise maintain a predetermined set of physical clusters 310 each comprising a predetermined number of GPU nodes 320 provided in the manner set forth in more detail above with reference to FIG. 1. In selected embodiments, the physical clusters 310 can be represented in equation form as illustrated in Equation 1 below.

$$C = \{ {C}_{i} \} \qquad ( Equation 1 )$$

In Equation 1, C represents the predetermined set of physical clusters 310; whereas, Cᵢ represents a specific physical cluster within the predetermined set. The predetermined number of GPU nodes 320 within a specific physical cluster Cᵢ can be represented as N(Cᵢ).

The combinatorial trading method 200 likewise can keep track of and otherwise maintain a predetermined set of outstanding virtual contracts. In selected embodiments, the outstanding virtual contract can be represented in equation form as illustrated in Equation 2 below.

$$K = \{ {k}_{j} \} \qquad ( Equation 2 )$$

In Equation 2, K represents the predetermined set of outstanding virtual contracts; whereas, kⱼ represents a specific outstanding virtual contract within the predetermined set. Each of the outstanding virtual contracts kⱼ can be associated with a predetermined number of GPU nodes 320. The predetermined number of GPU nodes 320 associated with a specific outstanding virtual contract kⱼ can be represented as N(kⱼ).

In selected embodiments, the combinatorial trading method 200 can support outstanding virtual contracts kⱼ that correspond to one or more physical clusters Cᵢ and/or outstanding virtual contracts kⱼ that do not correspond to one or more physical clusters Cᵢ. The combinatorial trading method 200 preferably can lay the outstanding virtual contracts kⱼ out on the physical clusters Cᵢ. Stated somewhat differently, the combinatorial trading method 200 can maintain an assignment a between the outstanding virtual contracts kⱼ and the physical clusters Cᵢ such that, for each physical cluster Cᵢ,

$${{\sum }_{{k}_{j}}}_{a ( {k}_{j} ) = {C}_{i}} ( N ( {k}_{j} ) = N ( {C}_{i} ) \qquad ( Equation 3 )$$

In accordance with Equation 3, the combinatorial trading method 200 allocate each GPU node N(Cᵢ) to an outstanding virtual contract kⱼ that is owned by a contract owner, such as a datacenter 330, an AI company or other market maker, without limitation. The combinatorial trading method 200 advantageously enables the predetermined set of outstanding virtual contracts K to be equal to the GPU nodes N(Cᵢ) in the physical clusters Cᵢ. In other words, if Equation 3 is presented as a function of X the current set of outstanding contracts K, the combinatorial trading method 200 can pack the set K of contracts into the physical clusters C if X(K)=T; otherwise, if X(K)=F, the combinatorial trading method 200 cannot pack the set K of contracts into the physical clusters C.

In selected embodiments, the combinatorial trading method 200 can keep track of a set of bids (or buy orders) b and a set of asks (or sell orders) a. Each bid b can include a number of nodes N(b) and a price P(b), and each ask a similarly can include a number of nodes N(a) and a price P(a). While bids may be arbitrary, each ask a can correspond to a specific virtual contract. In other words, a specific virtual contract K(a) associated with each ask a can be an element of the predetermined set of outstanding virtual contracts K as set forth in Equation 4 below.

$$\begin{matrix}K ( a ) ∈ K \\ with a first constraint of N ( a ) = N ( K ( a ) ) or \\ a second constraint of N ( a ) \leq N ( K ( a ) )\end{matrix} \qquad ( Equation 4 )$$

In accordance with the first constraint of Equation 4, the combinatorial trading method 200 can permit a seller to list only sell orders for contracts that the seller currently owns. The combinatorial trading method 200 alternatively can permit a seller who is willing to sell less than all of the owned contracts to place a sell order for a smaller number of contracts under the second constraint of Equation 4. In other words, the combinatorial trading method 200 can enable a seller who wants to sell N GPU nodes 320 to place separate, mutually exclusive offers to sell between one GPU node 320 and N GPU nodes 320 such that filling one of the separate offers to sell automatically cancels the other offers to sell.

The combinatorial trading method 200 advantageously can be configured to support providing a quotation for a bid received from a buyer. In other words, a buyer who wishes to buy a predetermined number of GPU nodes 320 can utilize the combinatorial trading method 200 for determining a cost of a contract to acquire the predetermined number of GPU nodes 320. The combinatorial trading method 200 can receive a quotation request from the buyer and, based upon a current collection of standing buy orders and/or standing sell orders, provide the requested quotation.

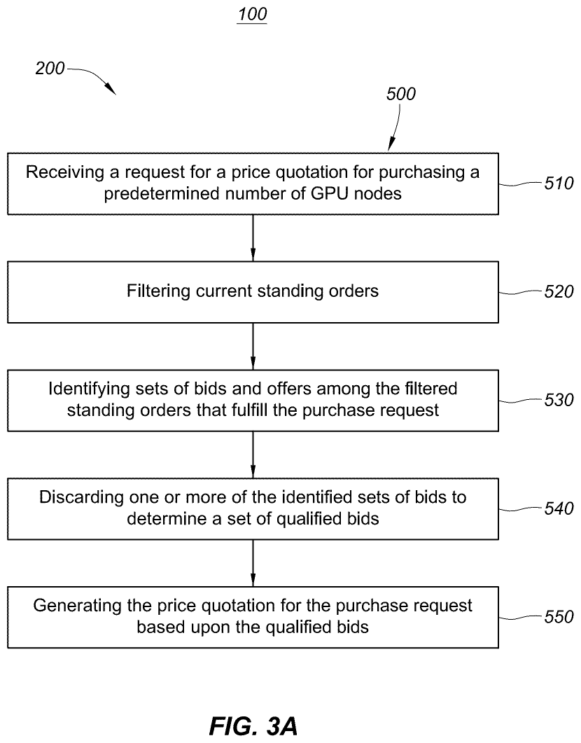

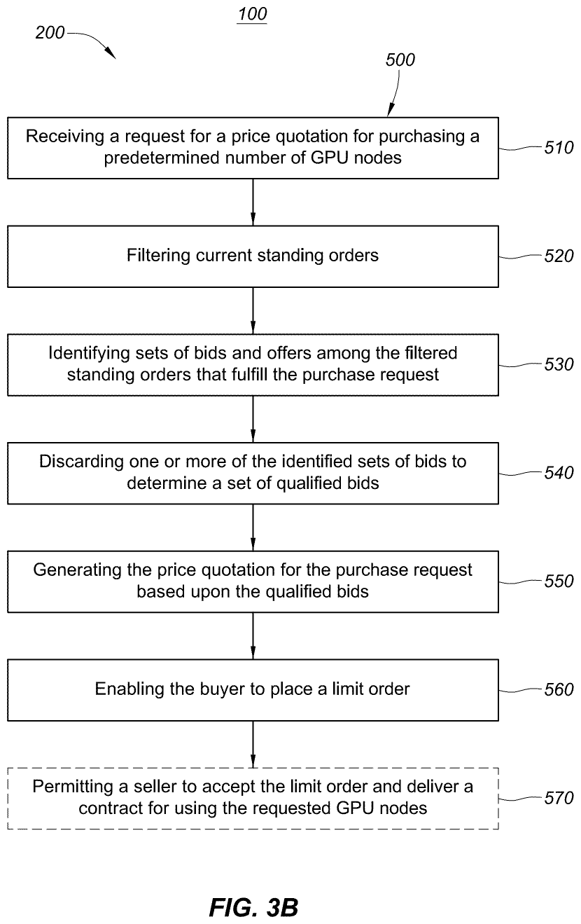

An exemplary method 500 for providing a quotation for a bid received from a buyer is illustrated in FIG. 3A. Turning to FIG. 3A, the bid quotation method 500 can include, at 510, receiving a request for a price quotation for purchasing a predetermined number of GPU nodes 320 (shown in FIGS. 1A-B). The bid quotation method 500, at 520, can filter the current collection of standing buy orders and/or standing sell orders. For example, the bid quotation method 500, at 520, can filter out all standing orders that are not the best price for their size. One or more sets of bids and offers among the filtered standing orders that fulfill the requested purchase can be identified, at 530. In selected embodiments, the bid quotation method 500, at 530, can identify one or more sets of bids and offers among the filtered standing orders that fulfill the requested purchase and any packing constraints. Exemplary packing constraints are discussed herein with reference to Equation 3. One or more of the identified sets of bids and offers can be discarded, at 540, to determine at least one set of qualified bids and offers.

At 550, the price quotation for the purchase request can be generated based upon the qualified bids and offers. The price quotation, for example, can comprise a minimum price among the set(s) of qualified bids and offers. To generate the price quotation, at 550, the bid quotation method 500 can solve a constrained optimization problem in which a set Ā⊂A of the standing sell orders can be fulfilled, a set B̅⊂B of the standing buy orders can be fulfilled, the buyer can be provided with a new virtual contract k_{new} with N(k_{new})=n, minimizing cost to the buyer while maintaining the packing constraint. The constrained optimization problem can be presented mathematically, for example, in the manner shown below in Equation 5.

$$\begin{matrix}{min}_{\overline{A} ⊂ A , \overline{B} ⊂ B} {\sum }_{a ∈ \overline{A}} P ( a ) - {\sum }_{b ∈ \overline{B}} P ( b ) \\ s . t . X ( 𝒦 \backslash \overline{A} ⋃ \overline{B} ⋃ \{ {k}_{new} \} )\end{matrix} \qquad ( Equation 5 )$$

An alternative embodiment of the bid quotation method 500 is shown in FIG. 3B. As shown in FIG. 3B, the bid quotation method 500 can further include, at 560, enabling the buyer to place a limit order. The bid quotation method 500, for example, can enable the buyer to place the limit order with a limit price p that is less than or equal to the price quotation generated, at 550. Payment for the limit order may be made in any conventional manner, including, but not limited to, via funds deposited with the combinatorial trading system 100 (shown in FIGS. 1A-B).

At 570, a seller is permitted to accept the limit order of the buyer and to deliver a (virtual) contract for using the requested GPU nodes 320. If the limit order is fulfilled by the seller, funds provided by the buyer can be held in an escrow account between the buyer and the seller. The funds can be released from the escrow account upon delivery of the (virtual) contract to the buyer. Additionally and/or alternatively, the funds can be offset and/or netted in the event of resale of the delivered contract.

For example, if a supplier has a standing sell order for eight GPU nodes 320, a market maker has a standing buy order for six GPU nodes 320, and a buyer wants to get a quote for two GPU nodes 320, the bid quotation method 500 can fulfill the eight-node sell order, giving six GPU nodes 320 to the market maker and two GPU nodes 320 to the new buyer. The bid quotation method 500 advantageously can be configured to support much more complicated trades, involving buying and selling lots of contracts, shuffling virtual contracts across the physical cluster layout, and/or getting the right surplus of GPU nodes 320 to give to the new buyer. When trades occur, any sell orders that were fulfilled as a part of the trade can be removed from the system with the seller receiving payment of the sale price or other limit price p, and any buy orders that were fulfilled can result in the buyer receiving a new virtual contract with for a predetermined number of GPU nodes 320 and making payment of the purchase price or other limit price p.

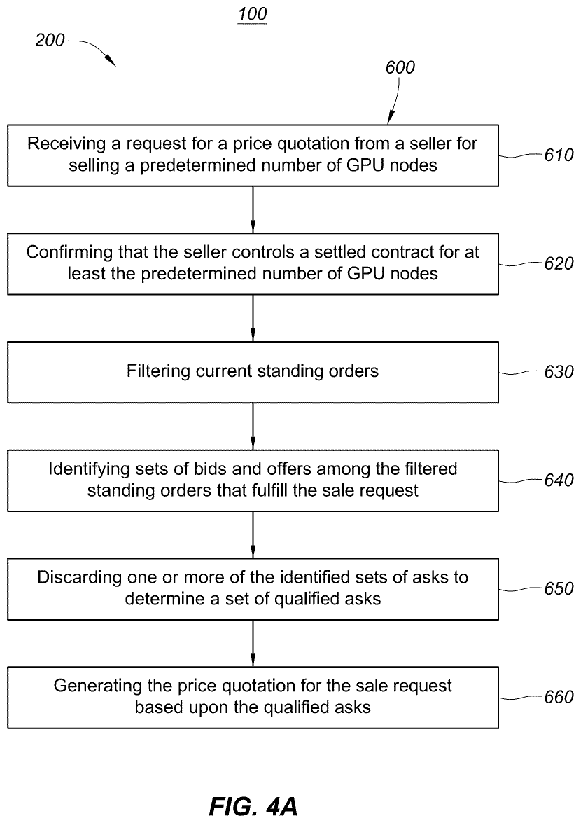

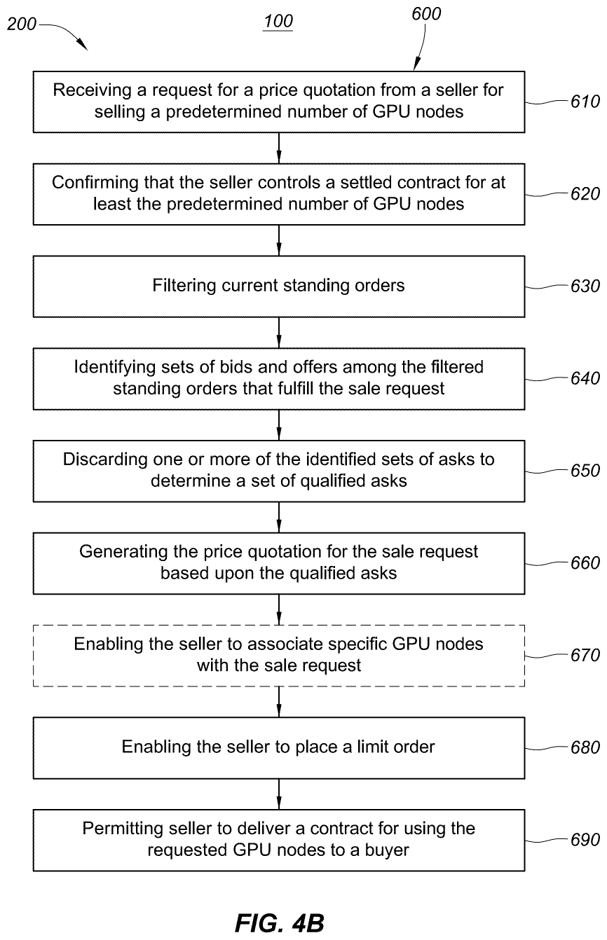

An exemplary method 600 for providing a quotation for an ask received from a seller is illustrated in FIG. 4A. The seller, for example, can comprise an owner of at least one (virtual) contract for a first preselected number of GPU nodes 320 (shown in FIGS. 1A-B) and/or a datacenter 330 (shown in FIG. 1B) with at least one (virtual) contract for a second preselected number of GPU nodes 320 within one or more clusters 320 (shown in FIGS. 1A-B). By submitting the ask, the seller can receive the quotation for an amount of money that the seller could receive if the available GPU nodes 320 were sold in view of current collection of standing buy orders and/or standing sell orders of the ask quotation method 600.

As illustrated in FIG. 4A, the ask quotation method 600 can include, at 610, receiving a request for a price quotation for selling a predetermined number of GPU nodes 320 (shown in FIGS. 1A-B). At 620, the ask quotation method 600 can confirm whether the seller controls one or more settled contracts for a number of GPU nodes 320 that is greater than or equal to the predetermined number. The ask quotation method 600, at 630, can filter the current collection of standing buy orders and/or standing sell orders. For example, the ask quotation method 600, at 630, can filter out all standing orders that are not the best price for their size. One or more sets of bids and offers among the filtered standing orders that fulfill the requested purchase can be identified, at 640. In selected embodiments, the ask quotation method 600, at 640, can identify one or more sets of bids and offers among the filtered standing orders that fulfill the requested purchase and any packing constraints. Exemplary packing constraints are discussed herein with reference to Equation 3. One or more of the identified sets of bids and offers can be discarded, at 650, to determine at least one set of qualified bids and offers.

At 660, the price quotation for the purchase request can be generated based upon the qualified bids and offers. The price quotation, for example, can comprise a maximum price among the set(s) of qualified bids and offers. To generate the price quotation, at 660, the ask quotation method 600 can solve a constrained optimization problem in which a set Ā⊂A of the standing sell orders can be fulfilled, a set B̅⊂B of the standing buy orders can be fulfilled, the seller can be provided with a new virtual contract k_{new} with N(k_{new})=n, maximizing profit to the seller while maintaining the packing constraint. The constrained optimization problem can be presented mathematically, for example, in the manner shown below in Equation 6.

$$\begin{matrix}{min}_{\overline{A} ⊂ A , \overline{B} ⊂ B} {\sum }_{b ∈ \overline{B}} P ( b ) - {\sum }_{a ∈ \overline{A}} P ( a ) \\ s . t . X ( 𝒦 \backslash \overline{A} \backslash \{ k \} ⋃ \overline{B} )\end{matrix} \qquad ( Equation 6 )$$

An alternative embodiment of the ask quotation method 600 is shown in FIG. 4B. Turning to FIG. 4B, the seller can have current contracts or otherwise own a number of GPU nodes 320 (shown in FIGS. 1A-B) that differs from the predetermined number of GPU nodes 320 recited in the request for a price quotation. If the number of GPU nodes 320 owned by the seller is greater than the predetermined number of GPU nodes 320 recited in the request for a price quotation, the ask quotation method 600, at 670, optionally can enable the seller to associate at least one specific GPU node 320 with the request for a price quotation. The ask quotation method 600, for example, can enable the seller to split a current (virtual) contract for GPU nodes 320.

The ask quotation method 600 can further include, at 680, enabling the seller to place a limit order. The ask quotation method 600, for example, can enable the seller to place the limit order with a limit price p that is greater than or equal to the price quotation generated, at 660. If a buyer accepts the limit order, the ask quotation method 600 can enable the buyer to tender payment in any conventional manner, including, but not limited to, via funds deposited with the combinatorial trading system 100 (shown in FIGS. 1A-B). At 690, the seller can deliver a (virtual) contract for using the requested GPU nodes 320 to the buyer. Funds provided by the buyer can be held in an escrow account between the buyer and the seller. The funds can be released from the escrow account upon delivery of the (virtual) contract to the buyer. Additionally and/or alternatively, the funds can be offset and/or netted in the event of resale of the delivered contract.

The combinatorial trading method 200 advantageously can extend beyond the market operations method 400 (shown in FIG. 2), the bid quotation method 500 (shown in FIGS. 3A-B) and the ask quotation method 600 (shown in FIGS. 4A-B). Stated somewhat differently, the combinatorial trading method 200 can provide a more general trading mechanism for supporting a wide range of trade types that do not readily fit into the categories of buy orders and sell orders. The combinatorial trading method 200, for example, can support a first exemplary trade by which an AI company or other market maker who currently owns or otherwise holds two sixteen-node contracts seeks to merge the two sixteen-node contracts into one thirty-two-node contract.

A second exemplary trade can involve an AI company or other market maker who currently owns or otherwise holds one thirty-two-node contract and seeks to divide the one thirty-two-node contract into two sixteen-node contracts. Additionally and/or alternatively, a third exemplary trade can be related to an AI company or other market maker who currently owns or otherwise holds one sixteen-node contract and seeks to expand the sixteen-node contract into a thirty-two-node contract. The combinatorial trading method 200 likewise can support a fourth exemplary trade by which a datacenter 330 (shown in FIG. 1B) that currently owns or otherwise holds a one hundred and twenty-eight-node contract and wishes to sell a first half of the contract on the market while retaining the second half of the contract.

As an example, a market participant who currently hold a first set S₁ of virtual contracts can utilize the combinatorial trading method 200 to request a price quotation for a generalized trade that will result in the market participant owning a second, different set of virtual contracts S₂. The first set S₁ of virtual contracts can comprise a subset of a larger collection of contracts K, or, mathematically, S₁⊂K. The combinatorial trading method 200 can provide the requested price quotation by solving an optimization problem, which can be presented mathematically, for example, in the manner shown below in Equation 7.

$$\begin{matrix}{min}_{\overline{A} ⊂ A , \overline{B} ⊂ B} {\sum }_{a ∈ \overline{A}} P ( a ) - {\sum }_{b ∈ \overline{B}} P ( b ) \\ s . t . X ( 𝒦 \backslash \overline{A} ⋃ \overline{B} \backslash {S}_{1} ⋃ {S}_{2} )\end{matrix} \qquad ( Equation 7 )$$

If the solution to the optimization problem provided by the combinatorial trading method 200 comprises a negative number, the market participant would receive payment for executing the generalized trade. The market participant alternatively would need to tender a payment for executing the generalized trade if the solution to the optimization problem is a positive number. In general, contracts for more nodes should always be worth more (per node) than contracts for fewer nodes; so, market participants typically will receive payment for splitting (virtual) contracts for GPU nodes 320 (shown in FIGS. 1A-B) and will need to make payment for merging (virtual) contracts for GPU nodes 320.

In selected embodiments, the combinatorial trading method 200 can be configured for supporting mutually-exclusive orders and/or partial filling of orders. A seller, in some cases, may wish to sell a subset of the total GPU nodes 320 owned by the seller, and a buyer can be willing to purchase a smaller number of GPU nodes 320 than a maximum number of GPU nodes 320 that the buyer is willing to purchase. To solve or otherwise address these cases, the combinatorial trading method 200 can allow mutually exclusive orders to be placed. The combinatorial trading method 200 can adapt the combinatorial matching problem for standard orders to permit mutually exclusive orders, for example, by adding a second check when doing order matching. In selected embodiments, the second check can include, when selecting an order as part of a match, the combinatorial trading method 200 can remove all other orders that are mutually exclusive with the selected order.

A special case can exist in certain circumstances, wherein a regular limit order can essentially be placed via the combinatorial trading method 200. Conventional Central Limit Order Books (or CLOBs) can partially fill limit orders when enough demand exists to meet part, but not all, of a given order at any particular time. In contrast, the combinatorial trading method 200 can accommodate parties who prefer partial fills of their bids and offers to waiting for complete fulfillment, for example, in low-liquidity environments. That is, if a bid is placed for a preselected number N of GPU nodes 320, the buyer and/or seller may be happy to purchase any number of nodes, which is less than or equal to the preselected number N, at the same price. The combinatorial trading method 200 can facilitate such trades by, for example, treating each trade as automatically listing orders for every integer number of GPU nodes 320 between one and the preselected number N, inclusive.

Additionally and/or alternatively, the combinatorial trading method 200, for market efficiency purposes, can create an order type in a matching engine such that an incoming order for a preselected number N of GPU nodes 320 can be automatically cancelled if another order for the preselected number N of GPU nodes 320 and/or a related time period falls or rises in price by a predetermined amount of money. This flexibility feature of the combinatorial trading method 200 can allow market makers to inject liquidity to permit larger-scale selling, for example, without creating price risk if an intended match is filled by some other mechanism.

The combinatorial trading method 200 can be configured for supporting orders with uniform time intervals and/or orders with non-uniform time intervals. In the present disclosure, selected features of the combinatorial trading method 200 are disclosed with reference to an example based upon uniform one-month time intervals for purposes of illustration only. Expanding upon this example, the combinatorial trading method 200 can be configured for supporting orders for a predetermined number of GPU nodes 320 that recite non-uniform time intervals, such as partial-months or weeks. Applications involving non-uniform time intervals does not impact the above-disclosed operation of the combinatorial trading method 200. Stated somewhat differently, the math associated with the combinatorial trading method 200 remains the same regardless of whether the time intervals are uniform and/or non-uniform.

If a buyer places an offer for a preselected number N of GPU nodes 320 with a time interval of a preselected number M of weeks, for example, the combinatorial trading method 200 can solve a two-dimensional matching problem based upon the preselected number M of weeks. The combinatorial trading method 200 can identify the standing orders that can fill an order in either direction (buy or sell) of M weeks and the preselected number N of GPU nodes 320 and can check the identified standing orders for the packing constraint (to ensure that an executed order would fit onto the physical substrate). The combinatorial trading method 200 then can select the identified standing order with lowest price for presentation to the buyer. Thereby, the combinatorial trading method 200 advantageously can permit trades at a scale that is smaller than an entire month, which is a relatively long time to purchase compute for in our ideal state, and/or can allow continuous training runs for longer than a single month, on a single datacenter 330.

For medium to large orderbook sizes and other circumstances, the combinatorial trading method 200 may become compute-intensive and thus take longer than ideal to provide the requested price quotations. Similarly to how stock exchanges quote a national best bid and offer even though the actual best bid and offer is often better than for consumers, however, the combinatorial trading method 200 advantageously can utilize combinatorial marching for generating a price quotation that is very (even arbitrarily) likely to actually be the best price (or best offer) for a selected (virtual) contract for a preselected number N of GPU nodes 320.

The idea of continuity can create a mismatch between buying and selling for the preselected number N of GPU nodes 320 and/or the preselected number M of weeks. Under certain circumstances, an efficient way to purchase, for example, thirteen GPU nodes 320 is to purchase fifteen GPU nodes 320 and sell two GPU nodes 320. It may not always be feasible to purchase eight GPU nodes 320 and five GPU nodes 320 and to combine these purchased GPU nodes 320 to provide the desired thirteen GPU nodes 320. Purchasing separate (virtual) contracts for purchasing GPU nodes 320 may not guarantee, for instance, that the purchased GPU nodes 320 will be associated with a common datacenter 330 (shown in FIG. 1B). Purchasing thirteen GPU nodes 320 thus likely will always be at least as expensive as purchasing eight GPU nodes 320 and five GPU nodes 320 together. In other words, although contracts for purchasing GPU nodes 320 usually can be split, it is not always possible to combine purchased contracts for GPU nodes 320 together.

Approximations of ideal matching typically should not compromise market efficiency. If it is possible to consistently make a profit by purchasing approximated (virtual) contracts and selling actual (virtual) contracts, any market inefficiency can be arbitraged away. Stated somewhat differently, if a very complicated trade allows purchase of, say, fifteen GPU nodes 320 at a price of $2.00/node and the current quoted sell price of fifteen GPU nodes 320 is $2.01/node, the difference in the price per node can comprise a correctable inefficiency that market makers can decide to accept.

One illustrative example of a heuristic that the combinatorial trading method 200 can utilize for approximating ideal matching can comprise Occam's razor. In accordance with Occam's razor, a simple method for purchasing a predetermined number N of GPU nodes 320 can be to determine a first quoted offer price for the predetermined number N of GPU nodes 320, a second quoted offer price for a number of GPU nodes 320 that is equal to a smallest power-of-two that is greater than the predetermined number N less a current best bid for the exponent of the smallest power-of-two and/or a third quoted offer price for a number of GPU nodes 320 that is equal to a smallest power-of-two that is greater than the predetermined number N minus one less a current best bid for the exponent of the smallest power-of-two less one. For example, if twenty-seven GPU nodes 320 are to be purchased, a first quoted offer price for the twenty-seven GPU nodes 320 can be determined, a second quoted offer price for thirty-two GPU nodes 320 less five GPU nodes 320 can be determined, and/or a third quoted offer price for thirty-one GPU nodes 320 less four GPU nodes 320 can be determined. If a (virtual) contract for the predetermined number N of GPU nodes 320 is purchased from a party who owns a contract for the predetermined number N of GPU nodes 320 can help guarantee that a shape of the node distribution will not change and thus, may preclude a need to check for bin packing.

Various other heuristics exist by which the combinatorial trading method 200 can approximate the least expensive GPU node(s) 320. For example, the combinatorial trading method 200 can include training a machine learning model on a set of simulated and/or actual bids and offers and measuring loss as a function of how much better a mathematically-ideal purchase to get the best bid or offer is for a buyer, seller or other requester relative to a suggestion provided by the machine learning model. Depending on the training mechanism utilized by the combinatorial trading method 200, the machine learning model can converge on toward the best bid or offer. The combinatorial trading method 200 thereby can solve the problem of using exponentially large computing resources using asymptotically good approximations for the matching engine of the exchange, continually confirming with ideal matching when necessary.

In the manner discussed in more detail herein, the combinatorial trading method 200 can be configured to trade physically-settled contracts for GPU nodes 320. The combinatorial trading method 200, in other words, can resolve constraints associated with matching different numbers of GPU nodes 320 such that a set of virtual nodes correspond to actually existing (or physical) GPU nodes 320. In selected embodiments, the combinatorial trading method 200 can be configured for trading futures contracts. Cash-settled, or synthetic, futures contracts, in other words, can be imagined to utilize data generated by the combinatorial trading method 200 as an index.

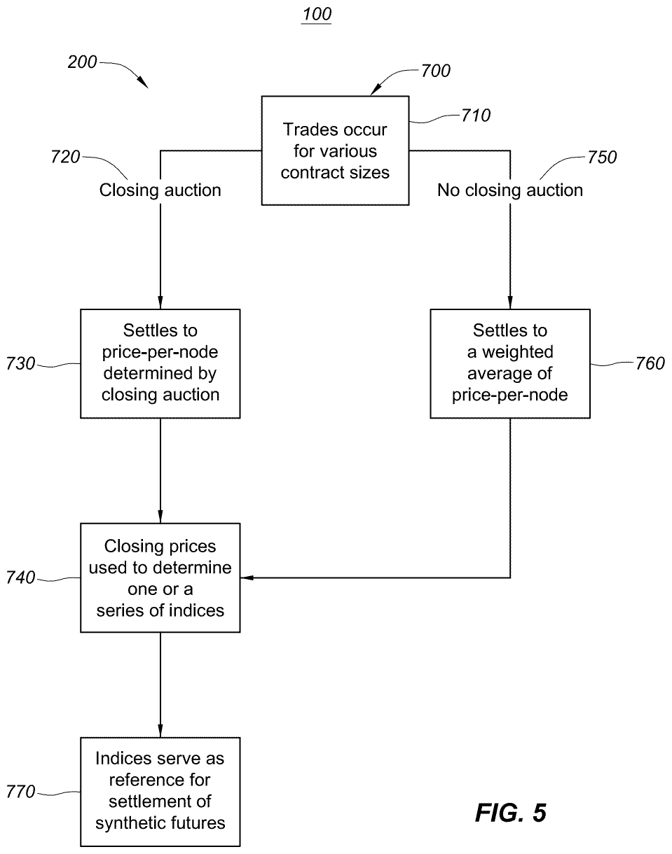

Another exemplary embodiment of the combinatorial trading method 200 is shown in FIG. 5. Turning to FIG. 5, the combinatorial trading method 200 is illustrated as including a method 700 for generating data for use as one or more indices for at least one synthetic futures contract. The index generation method 700 can include, at 710, supporting a plurality of trades for various contract sizes.

In selected embodiments, one or more of the trades can be associated with a closing auction. The trades, in other words, can comprise a first set of trades that are associated with a closing auction, at 720, and a second set of trades that are not associated with a closing auction, at 750. For the first set of trades, a price for each GPU node 320 (shown in FIGS. 1A-B) can be determined via the closing auction; whereas, a price for each GPU node 320 can be determined via a weighted average, at 760, for the second set of trades.

The combinatorial trading method 200 can determine one or more indices based upon at least one closing price associated with the plurality of trades, at 740. If more than one index is determined, at 740, the indices can be provided as a series of indices. At 770, the determined indices advantageously can serve as a reference for settlement of the at least one synthetic futures contract.

In selected embodiments, the combinatorial trading method 200 can include a mechanism for translating high-fidelity information into cash-settled futures that can be mapped onto reality. The combinatorial trading method 200 thereby can help ensure that the closing price of commodity futures actually represents the value of the underlying despite the compute futures involving different node sizes with distinctly different values.

While configured to operate during regular trading, the combinatorial trading method 200, in selected embodiments, may not resolve to a clean final price at the end of the day. The combinatorial trading method 200 thus can utilize a closing auction for mitigating this problem. At the end of each trading day, the combinatorial trading method 200 can treat the current bids and offers as bids in a closing auction mechanism. For a short period of time, new bids and offers will be able to be submitted into the closing auction.

The combinatorial trading method 200 thereby can solve a constrained maximization problem to choose a price at which the highest quantity of GPU nodes 320 are sold. The combinatorial trading method 200 can differ from a standard closing auction in two main ways. First, the combinatorial trading method 200 does not attempt to “clear the market.” Because the orders (or trades) have various contract sizes, the combinatorial trading method 200 may not be able to clear any bids above or offers below the resolved price per GPU nodes 320. Second, the combinatorial trading method 200 can have an additional constraint that the final virtual contracts must solve the bin-packing problem, and the combinatorial trading method 200 may be unable to just maximize the sale of GPU nodes 320. A final settlement price for a given day thereby can be a price given by the closing auction.

Absent a closing auction, the combinatorial trading method 200 may need to resolve a problem of creating a coherent price at which to cash-settle futures. Because splitting the futures market into many different contracts can create substantial liquidity issues and distract from the fungibility of the two GPU nodes 320, care has to be taken to trade only a handful of futures. The combinatorial trading method 200 absent a closing auction generally could generate an average the price per node of each trade between N/4 and N*4 GPU nodes 320, wherein N represents a predetermined number of GPU nodes 320, without limitation. The generated average the price per node of each trade advantageously can create a natural, convenient weighting that favors node sizes that are traded more often. The combinatorial trading method 200 thereby can support a four-node futures contract to get represent data from contracts between one GPU node 320 and sixteen GPU nodes 320, a 64-node contract between sixteen GPU nodes 320 and two hundred and fifty-six GPU nodes 320, and so on. As the market becomes more liquid, the index can track smaller portions of a day to become more accurate to the closing price.

The combinatorial trading method 200 thereby can be configured for trading short-term and/or medium-term reservations on computing resources. For example, the combinatorial trading method 200 can use market data from the spot exchange, either through a closing auction mechanism or simply by taking order-book data to build one or more indices that can do any combination of one or more of the following:

track the closing price of either all compute sold via the combinatorial trading method 200 or a certain range of sizes of virtual contracts sold;
track the value of a single size of compute; and/or
track spreads between different compute sizes such as, for example, a difference in price per node between a four-node contract and a sixty-four-node contract, without limitation.

This data can then either be used by the combinatorial trading method 200 or licensed to a separate designated contract market to list cash-settled futures, options, and derivatives contracts that settle to various prices partially and/or wholly determined by this market data.

Returning again to FIG. 2, the combinatorial trading method 200 can keep track of and otherwise maintain a predetermined set of physical clusters 310 each comprising a predetermined number of GPU nodes 320 provided in the manner set forth in more detail above with reference to FIG. 1. Here, the physical clusters 310 can be represented in equation form as illustrated in Equation 8 below.

$$C = \{ {C}_{i} \} \qquad ( Equation 8 )$$

In Equation 8, C can represent the predetermined set of physical clusters 310 each of which has a predetermined number N of GPU nodes 320. The predetermined number N of GPU nodes 320 within a specific physical cluster Cᵢ can be represented as a number N(Cᵢ,t) that comprises a function of discrete timesteps t, wherein the timesteps t∈T.

The combinatorial trading method 200 likewise can keep track of and otherwise maintain a predetermined set of outstanding virtual contracts. In selected embodiments, the outstanding virtual contract can be represented in equation form as illustrated in Equation 9 below.

$$K = \{ {k}_{j} \} \qquad ( Equation 9 )$$

In Equation 9, K represents the predetermined set of outstanding virtual contracts; whereas, kⱼ represents a specific outstanding virtual contract within the predetermined set. Each of the outstanding virtual contracts kⱼ can be associated with a predetermined number of GPU nodes 320. The predetermined number of GPU nodes 320 associated with a specific outstanding virtual contract kⱼ can be represented as N(kⱼ,t).

The contracts kⱼ do not necessarily correspond to any physical clusters Ci. In selected embodiments, the contracts kⱼ can be physically laid out on the clusters C. Stated somewhat differently, the combinatorial trading method 200 can maintain an invariant that there exists an assignment α:K→C of contracts to clusters, for each cluster Ci and for each timestep t∈T, in accordance with Equation 10 below.

$${{\sum }_{{k}_{j}}}_{α ( {k}_{j} ) = {C}_{i}} N ( {k}_{j} , t ) = N ( {C}_{i} , t ) \qquad ( Equation 10 )$$

The combinatorial trading method 200, in selected embodiments, can maintain an invariant at all times.

The combinatorial trading method 200 advantageously can enable the predetermined number N(kⱼ,t) of GPU nodes 320 associated with a specific outstanding virtual contract kⱼ to be equal to the predetermined number N(Cᵢ,t) of GPU nodes 320 within a specific physical cluster Cᵢ. In other words, the right hand side of Equation 10 includes an equal sign so every GPU node 320 has to be allocated to some contract that is owned by somebody. The combinatorial trading method 200 thus does not gradually fill clusters with contracts, but, instead, the current set of outstanding contracts K exactly adds up to the GPU nodes 320 in the physical clusters C associated with the combinatorial trading method 200. Each of the outstanding contracts K is owned, and the owners of the outstanding contracts K can include datacenters, market makers, or AI companies, without limitation.

In selected embodiments, the combinatorial trading method 200 can keep track of a set of bids (or buy orders) b and a set of asks (or sell orders) a. Each bid b can include a number of nodes N(b,t) and a price P(b), and each ask a similarly can include a number of nodes N (a,t) and a price P(a) with t∈T. While bids may be arbitrary, each ask a can correspond to a specific virtual contract. In other words, a specific virtual contract K(a) associated with each ask a can be an element of the predetermined set of outstanding virtual contracts K as set forth in Equation 11 below.

$$K ( a ) ∈ K with N ( a , t ) \leq N ( K ( a ) , t ) for all t ∈ T \qquad ( Equation 11 )$$

In accordance with the first constraint of Equation 11, the combinatorial trading method 200 can permit a seller to list only sell orders for contracts that the seller currently owns.

In selected embodiments, the bid quotation method 500 of FIGS. 3A-B advantageously can be configured to support providing a quotation for a bid received from a buyer. In other words, a buyer who wishes to buy a predetermined number N(t) of GPU nodes 320 over time t can utilize the bid quotation method 500 for placing a buy order b. The bid quotation method 500, for example, generate a cost estimate (or quotation) for buying such a contract given the current asks and bids in the bid quotation method 500. To generate the quotation, the bid quotation method 500 can solve a constrained optimization problem in which it will fulfill some set Ā⊂A of the standing sell orders, some set B̅⊂B of the standing buy orders, fill the incoming order b, and minimize cost to the buyer while maintaining a packing constraint as set forth in Equation 12 below.

$$\begin{matrix}{min}_{\overline{A} ⊂ A , \overline{B} ⊂ B} {\sum }_{a ∈ \overline{A}} P ( a ) - {\sum }_{b ∈ \overline{B}} P ( b ) \\ s . t . 3 a : \{ 𝒦 ⋃ B \} ↦ C \\ s . t . ∀ t ∈ 𝒯 {\sum }_{{k}_{j} ∈ 𝒦} \\ \end{matrix} \qquad ( Equation 12 )$$

The ask quotation method 600 (shown in FIGS. 4A-B) similarly can provide a price estimate (or quotation) for an incoming ask a. To generate the quotation for the incoming ask a, the ask quotation method 600 can require that a⊂Ã in Equation 12.

The bid quotation method 500 of FIG. 3B optionally can enable the buyer to place a limit order with a limit price p. Upon receiving the limit order, the bid quotation method 500 can solve the constrained optimization problem set forth above and, if the resulting surplus is nonnegative, can fill the limit order.

When a bid b is filled, the bid quotation method 500 can remove the bid b and replace the bid b with a contract k_{new} with N(k_{new}, t)=N(b, t). When an ask a gets filled, the bid quotation method 500 can replace its backing contract k=K(a) by a contract k′ that is smaller by the size of the ask a, that is, N(k′,t)=N(k, t)−N(a, t). When trades occur, in general, the bid quotation method 500 can fill a set of bids B̅⊂B and asks Ā⊂A. If K is the set of outstanding contracts prior to the trade (Ā, B̅), the new set of outstanding contracts K′ can be denoted by ξ(K,Ā,B̅).

The bid quotation method 500 and/or the ask quotation method 600 can allocate any surplus generated by the market in any number of ways. The generated surplus, for example, can be taken as revenue by a market operator and/or can be allocated to the incoming order. In selected embodiments, the generated surplus can be allocated via one or more complex rules. For example, the bid quotation method 500 and/or the ask quotation method 600 can allocate the generated surplus in a manner that is proportional to the limit prices of the filled orders in accordance with Equations 13A and 13B below.

$$1 〉 {t}_{∖} a \overline{c} {1}_{t}^{:} ∖ \frac{f > {t}_{1 ′ 1}}{{↖}^{∖} - {l}^{⊃} ′ ∖ ∖ ∼} 1 ′ b {:}^{- . j j 1} {1}^{J} i † ) ) - \frac{{I}^{\}} \} [ ) ] ∖}{{∇}_{:} , ∖ ⋅ … ⋅ l ′ ∖ - - . . : : t {l}^{`}} 13 A 13 B \qquad ( Equation 13 B )$$

In selected embodiments, the bid quotation method 500 and/or the ask quotation method 600 can enable a user to specify one or more colocation constraints. The bid quotation method 500 and/or the ask quotation method 600, in other words, can permit the user to specify that a new bid must be filled on the same cluster as an existing contract. For example, if the set of bids that have colocation constraints is represented by \hat{B} and if the contract that must be colocated with the set of bids with colocation constraints is represented by z(b∈\hat{B})∈K, the optimization problem set forth above can be presented in the set forth in Equation 14 below.

$$\text{??}$$

The bid quotation method 500 and/or the ask quotation method 600 can address any pinned orders in much the same way. For example, the bid quotation method 500 and/or the ask quotation method 600 can add a constraint that α(b)=cᵢ to Equation 14, wherein cᵢ is the cluster to which the order b is pinned.

In selected embodiments, the bid quotation method 500 and/or the ask quotation method 600 can fill incoming orders one at a time or alternatively accumulate the incoming orders over a batching period. If the bid quotation method 500 and/or the ask quotation method 600 accumulates the incoming orders, the batching period can comprise any suitable time interval. Exemplary batching periods can include, but are not limited to, to time intervals between one second and one day. The bid quotation method 500 and/or the ask quotation method 600 then can solve the surplus optimization problem once for the entire batch at the conclusion of the batching period.

By accumulating the incoming orders over the batching period, the bid quotation method 500 and/or the ask quotation method 600 can improve some of the computational efficiency problems with large numbers of orders and clusters. In this case, all of the orders in the batch can be treated as standing orders, and none of orders are required to be filled. In other words, there is no b∈B̅ constraint or a∈Ā constraint, but the other constraints all remain. Any subset of the orders A and B thereby may be filled. In this case, there is no incoming order to allocate surplus to; so, any surplus can be allocated using one of the other rules set forth above. The surplus, for example, can be allocated proportionally to limit price, without limitation.

In selected embodiments, the bid quotation method 500 and/or the ask quotation method 600 can treat different types of hardware as completely separate markets, represented by a “ticker.” The bid quotation method 500 and/or the ask quotation method 600 optionally can treat the different types of hardware as completely separate markets by default. For instance, the bid quotation method 500 and/or the ask quotation method 600 can treat H100 clusters where the GPU nodes 320 are connected over InfiniBand as a separate market called “h100i” from H100 clusters where the GPU nodes 320 are connected via Ethernet (“h100e”), which is a separate market from H100 clusters where the GPU nodes 320 have no such interconnect, denoted simply as “h100.” The bid quotation method 500 and/or the ask quotation method 600 can implement similar distinctions for region, access to cheap storage and/or availability of a high-bandwidth internet backhaul, without limitation.

The bid quotation method 500 and/or the ask quotation method 600 can treat different types of hardware as completely separate markets for any of several reasons. For example, buyers can care about one or more hardware parameters of the GPU nodes 320, and/or there can be significant variety in the GPU nodes 320 provided across different sellers. Treating different types of hardware as completely separate markets, however, can present a conundrum between further splitting the market and fragmenting market liquidity due to the further market splitting.

To address this conundrum, the bid quotation method 500 and/or the ask quotation method 600 can assign an instance type σ(b), σ(k), and σ(Ci) from a set of instance types S to the bids b∈B, contracts k∈T, and clusters Ci, respectively. The bid quotation method 500 and/or the ask quotation method 600 then can define a satisfaction relation S(t1, t2)⊂S×S which indicates whether t2 satisfies the instance type constraints demanded by instance type t1. For example, if t1 is “h100i” and t2 is “h100in,” the “i” denoting an InfiniBand fabric and the “n” denoting a fast internet uplink, S(t1, t2) would be satisfied because “h100in” provides all of the capabilities required by “h100i.” The bid quotation method 500 and/or the ask quotation method 600 then can add one or more constraints to the optimization problem by requiring that, for each cluster Ci and bid bj∈B̅, α(bj)=Ci only if S(σ(bj), σ(Ci)) is satisfied. Likewise for a contract k∈K, α(k)=Ci only if S(σ(k), σ(Ci)).

In selected embodiments, the combinatorial trading method 200 and other methodology disclosed herein can comprise one or more computer-implemented methods. The methodology, in other words, can be performed via one or more computer or other processing devices (or circuits). Each processing device can include, but is not limited to, a general-purpose computer, a smartphone, a programmed microprocessor, a micro-controller, a peripheral integrated circuit element, and other devices or arrangements of devices, which is capable of implementing the methodology disclosed herein. Additionally and/or alternatively, one or more of the features disclosed herein can be provided as a computer program product being encoded on one or more non-transitory machine-readable storage media.

As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for trading contracts for one or more standardized types of processing nodes, comprising:
receiving a request for a price quotation for purchasing a predetermined number of processing nodes via a processing circuit;
comparing one or more standing buy orders for buying respective first numbers of processing nodes at a first price and one or more standing sell orders for selling respective second numbers of processing nodes at a second price via the processing circuit;
filtering the standing buy orders and the standing sell orders via the processing circuit to provide a collection of filtered standing buy orders that offer a best first price for the first number of processing nodes and filtered standing sell orders that offer a best second price for the second number of processing nodes;
identifying at least one set of bids and offers among the collection of filtered standing buy orders and the filtered standing sell orders that fulfill the request for the price quotation via the processing circuit;
discarding one or more of the identified sets of bids and offers via the processing circuit to determine at least one set of qualified bids and offers; and
generating the requested price quotation based upon the at least one set of qualified bids and offers via the processing circuit.

2. The method of claim 1, wherein said receiving the request for the price quotation comprises receiving a request for a price quotation for purchasing a predetermined number of graphics processing units (GPU) nodes.

3. The method of claim 1, wherein said identifying the at least one set of bids and offers comprises identifying at least one set of bids and offers among the collection of filtered standing buy orders and the filtered standing sell orders that fulfill the request for the price quotation and at least one packing constraint.

4. The method of claim 1, further comprising maintaining a collection of current standing buy orders for buying respective first numbers of processing nodes at a current first price and current standing sell orders for selling respective second numbers of processing nodes at a current second price via the processing circuit.

5. The method of claim 1, further comprising receiving a limit order to purchase the predetermined number of processing nodes at a limit price that is less than or equal to the generated price quotation via the processing circuit.

6. The method of claim 5, further comprising enabling a seller to accept the limit order and to deliver a contract for using the predetermined number of processing nodes via the processing circuit, wherein the predetermined number of processing nodes are owned by the seller.

7. The method of claim 6, wherein said enabling the seller to deliver a contract includes enabling the seller to deliver a virtual contract for using the predetermined number of processing nodes.

8. A computer-implemented method for trading contracts for one or more standardized types of processing nodes, comprising:
receiving a request for a price quotation for selling a predetermined number of processing nodes from a seller via a processing circuit;
comparing one or more standing buy orders for buying respective first numbers of processing nodes at a first price and one or more standing sell orders for selling respective second numbers of processing nodes at a second price via the processing circuit;
filtering the standing buy orders and the standing sell orders via the processing circuit to provide a collection of filtered standing buy orders that offer a best first price for the first number of processing nodes and filtered standing sell orders that offer a best second price for the second number of processing nodes;
identifying at least one set of bids and offers among the collection of filtered standing buy orders and the filtered standing sell orders that fulfill the request for the price quotation via the processing circuit;
discarding one or more of the identified sets of bids and offers via the processing circuit to determine at least one set of qualified bids and offers; and
generating the requested price quotation for selling the predetermined number of processing nodes based upon the at least one set of qualified bids and offers via the processing circuit.

9. The method of claim 8, wherein said receiving the request for the price quotation comprises receiving a request for a price quotation for selling a predetermined number of graphics processing units (GPU) nodes.

10. The method of claim 8, further comprising confirming that the seller controls at least the predetermined number of processing nodes.

11. The method of claim 10, wherein said confirming that the seller controls at least the predetermined number of processing nodes comprises confirming that the seller controls a settled contract for at least the predetermined number of processing nodes.

12. The method of claim 8, further comprising enabling the seller to associate specific processing nodes with the price quotation request.

13. The method of claim 8, wherein said identifying the at least one set of bids and offers comprises identifying at least one set of bids and offers among the collection of filtered standing buy orders and the filtered standing sell orders that fulfill the request for the price quotation and at least one packing constraint.

14. The method of claim 8, further comprising maintaining a collection of current standing buy orders for buying respective first numbers of processing nodes at a current first price and current standing sell orders for selling respective second numbers of processing nodes at a current second price via the processing circuit.

15. The method of claim 8, further comprising receiving a limit order from the seller to sell the predetermined number of processing nodes at a limit price that is greater than or equal to the generated price quotation via the processing circuit.

16. The method of claim 8, further comprising enabling a buyer to accept the limit order and enabling the seller to deliver a contract to the buyer for using the predetermined number of processing nodes via the processing circuit.

17. The method of claim 16, wherein said enabling the seller to deliver a contract includes enabling the seller to deliver a virtual contract for using the predetermined number of processing nodes.

18. The method of claim 16, further comprising holding payment from the buyer to the seller in an escrow account until the seller delivers the contract to the buyer.
